(19) United States
(12) Patent Application Publication
(10) Pub. No.: US 2011/0258095 A1
(43) Pub. Date: Oct. 20, 2011

(54) Method and system for creating and issuing a deferred coupon preferred security

(76) Inventors: David A. Seaman, Short Hills, NY (US); Wenyan Winston Ma, Short Hills, NY (US)

(21) Appl. No.: 11/715,192

(22) Filed: Mar. 7, 2007

Related U.S. Application Data
(60) Provisional application No. 60/779,764, filed on Mar. 7, 2006.

(51) Int. Cl. G06Q 40/00

(52) U.S. Cl. 705/35

(57) ABSTRACT

A corporate debt security includes an optional payment deferral feature allowing deferral of coupon interest on the debt security without triggering default, and a mandatory payment deferral feature allowing deferral of coupon interest on the debt security without triggering default. The corporate debt security also includes a provision to issue at least one warrant on corporate common stock at a predetermined time after any payment deferral. The warrant exercise price is equal to or greater than the price of corporate common stock, as determined when the warrant is issued. The debt security is issued in exchange for value.

This application claims priority to U.S. Provisional Application Serial No., 60/779,764 entitled Enhanced Trust Preferred Coupon Deferral Solution To GAAP EPS Problem, filed Mar. 7, 2006, the disclosure of which is incorporated herein by reference.

### BACKGROUND

Hybrid financial instruments and securities that includes features of debt and equity are known. Long-term debt instruments are needed that provide equity credit for rating purposes while minimizing or eliminating equity dilution and adverse impact on earnings per share.

The preceding description is not to be construed as an admission that any of the description is prior art relative to the present invention.

### SUMMARY OF THE INVENTION

In one embodiment, systems and methods are provided to create and issue a corporate debt security. The systems and methods comprise creating a corporate debt security that comprises: an optional payment deferral feature allowing deferral of coupon interest on the debt security without triggering default; and a mandatory payment deferral feature allowing deferral of coupon interest on the debt security without triggering default. The corporate debt security further comprises a provision to issue at least one warrant on corporate common stock at a predetermined time after any payment deferral. The warrant exercise price is equal to or greater than the price of corporate common stock, as determined when the warrant is issued. The system and method further comprise issuing the debt security in exchange for value.

In another embodiment, the corporate debt security and the corporate common stock are issued by the same corporate entity. In another embodiment, the corporate debt security and the corporate common stock are issued by different but related corporate entities. In another embodiment, the debt security term is at least thirty years. In another embodiment, the predetermined time is after optional payment deferral. In another embodiment, the predetermined time is one year after optional payment deferral. In another embodiment, the predetermined time is after mandatory payment deferral. In another embodiment, the predetermined time is one year after mandatory payment deferral. In another embodiment, the predetermined time is five years after mandatory payment deferral.

In one embodiment, systems and methods are provided to create and issue a corporate debt security. The systems and methods comprise creating a corporate debt security that comprises: a statement of intent by the debt security issuer to replace the debt security with another security that is equal or greater in equity content to the debt security; and a commitment by the debt security issuer to replace the debt security with another security that is equal or greater in equity content to the debt security. The corporate debt security further comprises: an optional payment deferral feature allowing deferral of coupon interest on the debt security without triggering default; and a mandatory payment deferral feature allowing deferral of coupon interest on the debt security without triggering default. The corporate debt security further comprises: a provision to issue at least one warrant on corporate common stock at a predetermined time after any payment deferral. The warrant exercise price is equal to or greater than the price of corporate common stock, as determined when the warrant is issued. The systems and methods further comprise issuing the debt security in exchange for value.

In one embodiment a corporate debt security comprises an optional payment deferral feature allowing deferral of coupon interest on the debt security without triggering default, and a mandatory payment deferral feature allowing deferral of coupon interest on the debt security without triggering default. The corporate debt security further comprises a provision to issue at least one warrant on corporate common stock at a predetermined time after any payment deferral. The warrant exercise price is equal to or greater than the price of corporate common stock, as determined when the warrant is issued.

The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates a system according to an embodiment; and

FIG. 2 illustrates a method according to an embodiment.

It is understood that the drawings are for illustration only and are not limiting.

### DETAILED DESCRIPTION OF THE DRAWINGS

In the embodiments described herein, certain corporate debt instruments include a provision to issue warrants on corporate common stock upon certain conditions. When issued, the warrants are priced at or above the then-current price of corporate common stock. The warrants are elements of an alternative payment mechanism (APM) incorporated in the terms of the debt instrument. The warrants are only issued when the issuer defers coupon payments on the debt instrument and funds from issue of the warrants are used to pay those deferred coupon payments on the debt instrument. Such an APM serves to facilitate better equity credit from rating agencies for the issue of corporate debt instruments. Issue of warrants as a type of APM also helps to minimize potential adverse impact on earnings per share (EPS), so long as the warrant is priced at or above the then-current common stock price. Details of such a debt instrument are described below in greater detail

The issue of straight debt instruments and straight equity instruments by corporations is well known. With a straight debt instrument (e.g., a bond), the holder is generally entitled to periodic interest payments, and eventual repayment of the principal. However, the debt holder has no ownership interest in the issuing corporation. With a straight equity instrument (e.g., common stock), the holder has an ownership interest in the issuing corporation, but generally has no right to receive any regular payments. A hybrid instrument can incorporate various features traditionally associated with a debt instrument and/or an equity instrument, and the issue of corporate hybrid instruments is known.

Debt instruments typically include provisions for regular payment of interest on the debt, often referred to as coupon payments. Debt instruments also generally have a maturity at which date any remaining balance on the principal is due, although a maturity is not required. A debt instrument might also include a provision by which it is exchanged for some other instrument at a later date. When the debt instrument has an exchange provision, that exchange might be at a date certain, or it might occur only after certain conditions occur.

In formulating a corporate rating, rating agencies consider many factors, including a company's outstanding debt and equity. For rating purposes, there are advantages to getting some equity credit with a debt issue. If the debt instrument has provisions for either an optional or mandatory deferral of coupon payments on the debt instrument, then to get equity credit from day one of issue, the rating agency requires an APM in the debt instrument prospectus. An APM is a way to raise proceeds to pay the deferred debt coupon interest, and issue of equity securities to pay deferred debt coupon interest is one such APM. Rating agencies also view such an APM as a way to get equity credit for issue of a debt instrument. One solution is thus to include a provision in the debt instrument for issue of common stock as part of an APM. Under those circumstances, issue of common stock is not automatic, but is contingent upon deferral of debt coupon interest, and if common stock issues, then it occurs it only occurs after the initial debt issue. There was a realization in late 2005 and early 2006 that issue of common stock as part of an APM presents a potential disadvantage in that such an issue is dilutive for previous equity holders. Further, any issue of common stock will impact earnings per share. Use of a warrant that is priced equal to or greater than the then-current common stock price (i.e., the warrant is at or out of the money when issued) resolves both problems. Issue of such a warrant is not immediately dilutive, because the warrants will only be redeemed if it is in the money. Further, until the warrants are in the money and redeemed, there are no additional shares issued and therefore no impact on EPS.

An Example System

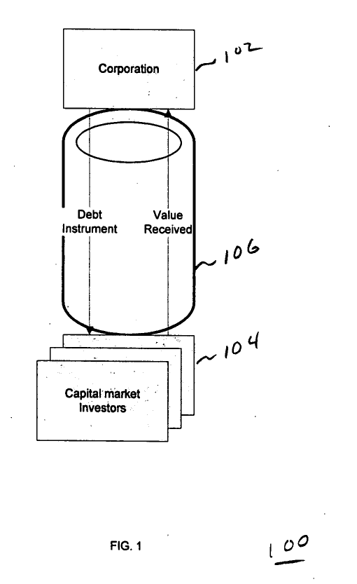

Referring to FIG. 1, an example system 100 according to one embodiment includes corporate entity 102 and capital market investors 104. Corporate entity 102 and capital market investors 104 are interconnected by a data and document network 106. Network 106 is used to communicate between corporate entity 102 and capital market investors 104. Although not illustrated, corporate entity 102 and capital market investors 104 include and make use of general and special purpose computers, which include one or more central processor units (CPU); volatile and non-volatile memory (RAM, ROM, EPROM, Flash etc.); software code and data storage devices (floppy drives, hard drives, CDs, DVDs, etc.); input/output devices (keyboards, monitors, pointing devices, printers, etc.); and network communication devices (modems, Ethernet cards, WiFi cards, etc.).

An Example Method

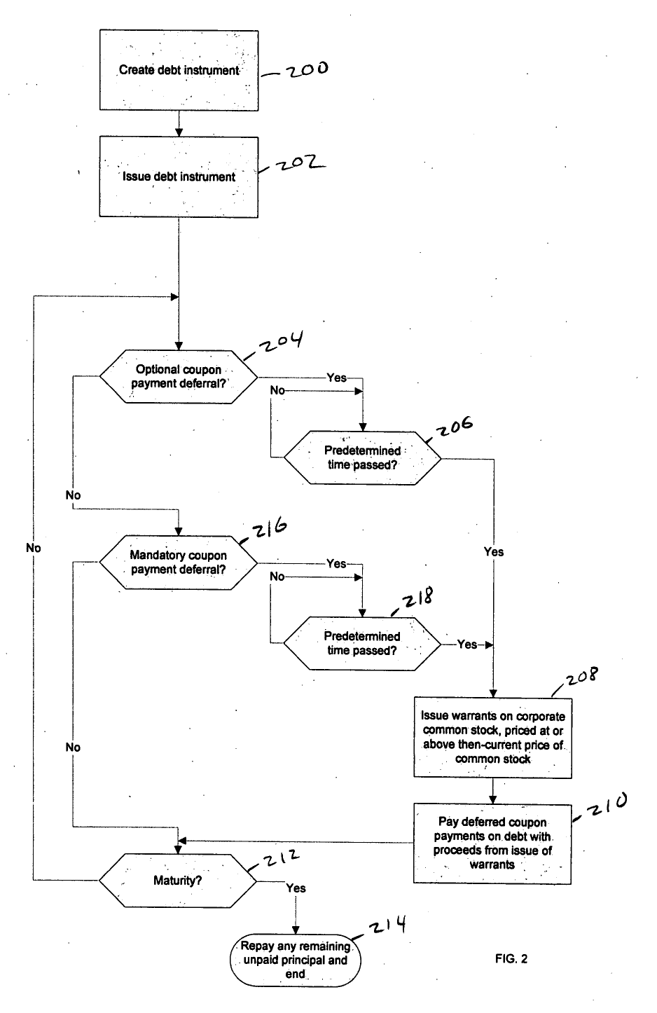

Referring to FIG. 2, steps in an example method according to one embodiment begin at step 200 with corporate entity 102 of system 100 creating a long-term debt instrument. In one embodiment, the maturity of the debt instrument is at least 10 years. In other embodiments, the maturity of the debt instrument is much longer, such as 60 years, or some intermediate maturity.

In various embodiments, the debt instrument created at step 200 includes additional provisions. One such provision is a statement of intent by the debt issuer to replace the debt security with another security that is equal or greater in equity content to the debt instrument. Another such provision is a commitment or declaration of covenant by the debt issuer to replace the debt security with another security that is equal or greater in equity content to the debt instrument.

In another embodiment, a provision in the debt instrument is an optional payment deferral feature that allows the issuer to defer coupon interest payments on the debt instrument without triggering default. Such an optional deferral can be effective for a period of time, such as up to five years.

In another embodiment, if there is an optional payment deferral, then an alternative payment mechanism is implemented after a predetermined period of time, such as one year after the first optional payment deferral.

In another embodiment, a provision in the debt instrument is a mandatory payment deferral feature that requires the issuer to defer coupon interest payments on the debt instrument without triggering default. In one embodiment the mandatory payment deferral feature is effective upon breach of certain financial triggers. Such a mandatory deferral can be effective for a period of time, such as up to seven years.

In another embodiment, if there is a mandatory payment deferral, then an alternative payment mechanism is implemented after a predetermined period of time, such as one year after the first mandatory payment deferral.

In another embodiment, if there is both an optional payment deferral and a mandatory payment deferral, then an alternative payment mechanism is implemented after a predetermined period of time, such as five years. In one embodiment, the predetermined period of time is measured from the first mandatory payment deferral.

In one embodiment, the debt instrument created at step 200 also includes a provision to issue one or more warrants on common stock of corporate entity 102 at a predetermined time after any payment deferral. In one embodiment, issue of the warrant is an alternative payment mechanism. In one embodiment, the warrant exercise price is equal to the price of corporate common stock, determined when the warrant is issued. In one embodiment, the warrant exercise price is greater than the price of corporate common stock, determined when the warrant is issued.

At step 202, corporate entity 102 and system 100 issue the debt instrument to the capital market, where it is purchased by capital market investors 104, in exchange for value.

At step 204, system 100 determines whether there has been any optional coupon payment deferral, and if so, then at step 206, system 100 determines whether a predetermined time, such as one year, has passed.

If at step 204 there was an optional coupon payment deferral and at step 206 the predetermined time has passed, then at step 208, corporate entity 102 issues at least one warrant on common stock of corporate entity 102. The warrant exercise price is equal to or greater than the then-current price of common stock of corporate entity 102. It is also possible that the warrant is issued by a related corporate entity, not by corporate entity 102.

At step 210, corporate entity 102 uses the proceeds from issue of the warrants to pay the deferred coupon payments on the debt instrument to capital market investors 104.

At step 212, system 100 determines whether the debt instrument maturity date has been reached and if so, at step 214, corporate entity 102 pays any remaining unpaid principal to capital market investors 104 and the process ends.

If at step 212, system 100 determines that the debt instrument maturity has not been reached, then system 100 loops to step 204.

If at step 204, system 100 determines that there has been no optional coupon payment deferral, then at step 216, system 100 determines whether there has been a mandatory coupon payment deferral. If so, then at step 218, system 100 determines whether a predetermined time, such as one year, has passed.

If at step 216 there was a mandatory coupon payment deferral and at step 218 the predetermined time has passed, then at step 208, corporate entity 102 issues at least one warrant on common stock of corporate entity 102. The warrant exercise price is equal to or greater than the then-current price of common stock of corporate entity 102.

At step 210, corporate entity 102 uses the proceeds from issue of the warrants to pay the deferred coupon payments on the debt instrument to capital market investors 104. Then, at step 212, system 100 determines whether the debt instrument maturity date has been reached and if so, at step 214, corporate entity 102 pays any remaining unpaid principal to capital market investors 104 and the process ends.

If at step 216, system 100 determines that there was no mandatory coupon payment deferral, then at step 212, system 100 determines whether the debt instrument maturity date has been reached and if so, at step 214, corporate entity 102 pays any remaining unpaid principal to capital market investors 104 and the process ends.

In an embodiment that is not entirely illustrated in FIG. 2, it is possible that there is both an optional coupon payment deferral and a mandatory coupon payment deferral. In that instance the predetermined time after payment deferral is measured from the beginning of mandatory payment deferral.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A computer-implemented method for issuing a corporate debt security comprising:
creating, using a programmed computer, a corporate debt security by providing:
an optional payment deferral feature allowing deferral of coupon interest on the debt security without triggering default;
a mandatory payment deferral feature allowing deferral of coupon interest on the debt security without triggering default; and
a provision to issue at least one warrant on corporate common stock at a predetermined time after any payment deferral, wherein the warrant exercise price is equal to or greater than the price of corporate common stock, as determined when the warrant is issued,
wherein the programmed computer is connected to a computer of an investor through a network; and
issuing the debt security to the investor in exchange for value through the network using the programmed computer.

2. A method according to claim 1, wherein the corporate debt security and the corporate common stock are issued by the same corporate entity.

3. A method according to claim 1, wherein the corporate debt security and the corporate common stock are issued by different but related corporate entities.

4. A method according to claim 1, wherein the debt security term is at least thirty years.

5. A method according to claim 1, wherein the predetermined time is after optional payment deferral.

6. A method according to claim 1, wherein the predetermined time is one year after optional payment deferral.

7. A method according to claim 1, wherein the predetermined time is after mandatory payment deferral.

8. A method according to claim 1, wherein the predetermined time is one year after mandatory payment deferral.

9. A method according to claim 1, wherein the predetermined time is five years after mandatory payment deferral.

10. A computer-implemented method for issuing a corporate debt security comprising:
creating, using a programmed computer, a corporate debt security by providing:
a statement of intent by the debt security issuer to replace the debt security with another security that is equal or greater in equity content to the debt security;
a commitment by the debt security issuer to replace the debt security with another security that is equal or greater in equity content to the debt security;
an optional payment deferral feature allowing deferral of coupon interest on the debt security without triggering default;
a mandatory payment deferral feature allowing deferral of coupon interest on the debt security without triggering default; and
a provision to issue at least one warrant on corporate common stock at a predetermined time after any payment deferral, wherein the warrant exercise price is equal to or greater than the price of corporate common stock, as determined when the warrant is issued,
wherein the programmed computer is connected to a computer of an investor through a network; and
issuing the debt security to the investor in exchange for value through the network using the programmed computer.

11. (canceled)

12. A computer usable medium having a computer readable program code embodied therein, the computer readable program code adapted to be executed to implement a method for issuing a corporate debt security, the method comprising:
creating a corporate debt by providing:
an optional payment deferral feature allowing deferral of coupon interest on the debt security without triggering default;
a mandatory payment deferral feature allowing deferral of coupon interest on the debt security without triggering default; and
a provision to issue at least one warrant on corporate common stock at a predetermined time after any payment deferral, wherein the warrant exercise price is equal to or greater than the price of corporate common stock, as determined when the warrant is issued;
connecting to a computer of an investor through a network; and
issuing the debt security to the investor in exchange for value.

13. A programmed computer for issuing a corporate debt security, comprising:
a memory having at least one region for storing computer executable program code; and
a processor for executing the program code stored in the memory, wherein the program code comprises:
code to create a corporate debt security by providing:
an optional payment deferral feature allowing deferral of coupon interest on the debt security without triggering default;
a mandatory payment deferral feature allowing deferral of coupon interest on the debt security without triggering default; and
a provision to issue at least one warrant on corporate common stock at a predetermined time after any payment deferral, wherein the warrant exercise price is equal to or greater than the price of corporate common stock, as determined when the warrant is issued; and
code to issue the debt security in exchange for value through a network connected to an investor.

14. (canceled)
